(19) United States
(12) Patent Application Publication
(10) Pub. No.: US 2026/0147611 A1
(43) Pub. Date: May 28, 2026

(54) Method For Management of Digital Connectors and Workflows

(71) Applicant: Nu Computing Abstraction Layer LLC, Bloomfield, NJ (US)

(72) Inventors: Yagmur Sahin, Verona, NJ (US); Melih Abdulhayoglu, Montcalir, NJ (US)

(21) Appl. No.: 19/349,159

(22) Filed: Oct. 3, 2025

Related U.S. Application Data
(60) Provisional application No. 63/705,004, filed on Oct. 8, 2024.

(51) Int. Cl. G06F 9/48

(52) U.S. Cl. CPC G06F 9/4881

(57) ABSTRACT

There is provided a method for management of digital connectors and workflows which includes a device connected to a user interface in communication with an API gateway which communicates with an application server. Calls are made from the application server to a database which returns the information and data requested. The application server communicates with a workflow engine, transferring any information or data received from the database. The workflow engine communicates with cloud storage/services and logging/monitoring services.

### CROSS REFERENCE TO RELATED APPLICATIONS

This application claims the benefit of and priority to U.S. Provisional Patent Application Ser. No. 63/705,004 filed on Oct. 8, 2024 and incorporated herein by reference in its entirety.

### FIELD OF THE INVENTION

The present invention relates to connectivity to a platform, and more particularly to managing digital connectors and workflows.

### BACKGROUND

Presently, the process of setting up and executing workflows involves a more manual and technically demanding approach. Users typically have to interact directly with flow editors to input the necessary account details and configure each parameter of the workflow manually. This method requires users to have a certain level of technical expertise and familiarity with the system's underlying structure, which could be a significant barrier for non-technical users.

Some the prior and existing methods include the following.

Manual Configuration in Flow Editors: This process requires users to open a flow editor where they manually type in all required inputs and configure each aspect of the workflow. It includes a technical requirement which requires understanding of the workflow's architecture and the specific integrations. User Involvement: High degree of user interaction with technical tools is necessary.

Direct Editing of Workflow Parameters: This process has adjustments to the workflow configurations which are made directly in the editor, often involving detailed knowledge of each field and how changes affect the overall process. There is a complexity with this process as each workflow modification requires careful consideration of dependencies and potential impacts on related processes.

Use of Predefined Templates: The availability of this method is limited, as some systems offer templates as a starting point, but they still require significant customization to meet specific user needs. In order to customize, the effort is largely manual, requiring users to alter the template within the flow editor. These methods, while functional, pose significant challenges such as accessibility, efficiency, and scalability. For accessibility, non-technical users find it difficult to navigate complex editors and configure workflows correctly. As to efficiency, manually entering and adjusting details is time-consuming and prone to errors. Finally, as to scalability, the managing of multiple workflows simultaneously becomes cumbersome as the complexity of integrations increases.

The prior and existing methods for setting up and managing workflows, which primarily involve manual configurations through flow editors, have several other significant disadvantages. These include high technical barriers, time consuming processes, increased error rates, lack of efficiency, limited scalability, and dependency on technical staff. Each are discussed briefly below.

High Technical Barrier: The necessity for users to interact directly with flow editors and understand technical details creates a steep learning curve. This barrier can prevent non-technical users from effectively utilizing the system, thereby limiting the user base and reducing accessibility.

Time-Consuming Process: Manually entering and configuring each required detail for workflows is labor-intensive. This not only slows down the initial setup process but also makes it cumbersome to update or modify workflows as business needs change.

Increased Error Rate: Manual data entry and configuration adjustments are prone to human error. Mistakes made during the setup phase can lead to workflow failures, incorrect data processing, or other operational issues that are often difficult and time-consuming to diagnose and correct.

Lack of Efficiency: The need to manually open and adjust workflows within an editor for every single change or new integration can drastically reduce operational efficiency. This method does not scale well, especially for organizations managing numerous or complex workflows.

Limited Scalability: As the number of workflows and their complexity increases, managing them through traditional flow editors becomes increasingly unwieldy. This limitation can hinder the growth and adaptability of businesses, particularly those that require rapid scaling to meet evolving demands.

Dependency on Technical Staff: Organizations often rely heavily on IT staff or those with specific technical expertise to set up and maintain workflows. This dependency can create bottlenecks in workflow management and increase operational costs due to the need for specialized personnel.

These disadvantages highlight the need for a more streamlined, automated, and user-friendly approach which aims to simplify the workflow setup process, and make it more accessible and error-resistant while enhancing overall operational efficiency.

### SUMMARY OF THE INVENTION

The present invention with an “easy use of flows” system addresses the above issues by eliminating the need for direct interaction with flow editors for routine setup tasks, making the process more accessible and less error-prone for all users.

The present invention is an “easy use of flows” innovation which specifically aims to streamline the process of identifying necessary account details and automating user interactions within this context. It enhances the capabilities of a flow generation system by improving the efficiency and user-friendliness of setting up and executing flows, thereby reducing manual effort and further optimizing the management of digital connectors and workflows. This integrated enhancement makes it more efficient and user-friendly for those operating within highly dynamic and integration-heavy environments.

The present invention is designed to simplify and enhance the user experience in setting up and managing workflows within digital environments. Its primary purpose is to streamline the process of identifying all necessary account details required to execute a flow effectively. This system proactively prompts the user to provide all relevant information before the initiation of the workflow, ensuring that all dependencies and requirements are addressed upfront, thereby minimizing errors and interruptions during execution.

The present invention includes the automation of the initial setup, enhanced user interface, reduction in manual errors, increased efficiency, and scalability and adaptability. For automation of initial setup, the present invention automates the gathering of essential account details by identifying what information is needed for each flow and prompting the user to provide these details at the beginning of the setup process.

For Enhanced User Interface, the present invention develops a user-friendly interface that guides users through the account setup process, making it easy for users with varying levels of technical expertise to configure and initiate workflows.

For Reduction in Manual Errors, by systematizing the data input process, the invention aims to reduce the likelihood of errors that can occur when users manually input or configure account details for workflows.

For Increased Efficiency, the present invention streamlines the flow setup process, significantly reducing the time and effort required to launch new workflows, which is particularly beneficial in environments with a high volume of integrations and dependencies.

For scalability and adaptability, the present invention ensures that the system is scalable and adaptable to accommodate a wide range of workflows, from simple to complex, across various industries and technological platforms.

This invention targets a crucial pain point in workflow management systems—the initial setup phase where accurate account details are crucial. By addressing this, the invention significantly improves the efficiency and reliability of executing automated workflows.

The present invention is a method for management of workflow processes in applications which comprises accessing a computing device which displays a user interface, and the user interface in communication with an application programming interface (api) gateway. The method includes communicating with an application server by the api gateway and requesting, by the api gateway, from the application server to a database for information and data. The method returns from the database the information and data to the application server. The method of the invention then transfers, by the application server, the information and data received from the database to a workflow engine. In the method, this workflow engine communicates the information and data received to a cloud storage and with logging and monitoring services.

### BRIEF DESCRIPTION OF THE DRAWINGS

Exemplary embodiments are illustrated in referenced figures. Dimensions of components and features shown in the figures are generally chosen for convenience and clarity of presentation and are not necessarily shown to scale. The figures are listed below where:

FIG. 1 illustrates the entities in the present invention Parjects based application development system.

FIG. 2 illustrates the application development lifecycle using Parjects.

FIG. 3 is overall schematic of abstraction-based development system provided by Parjects.

FIG. 4 is a schematic of an application instance scenario with different Parject each is supported via different API providers.

FIG. 5 is a schematic illustration of the connections of a computing system.

FIG. 6 is a schematic of the present invention.

### DETAILED DESCRIPTION

The present invention is based on a computing abstraction layer which is formed of Parjects for any set of capabilities in the world. Parject based application development system has a set of entities that makes the platform available for end users and application developers.

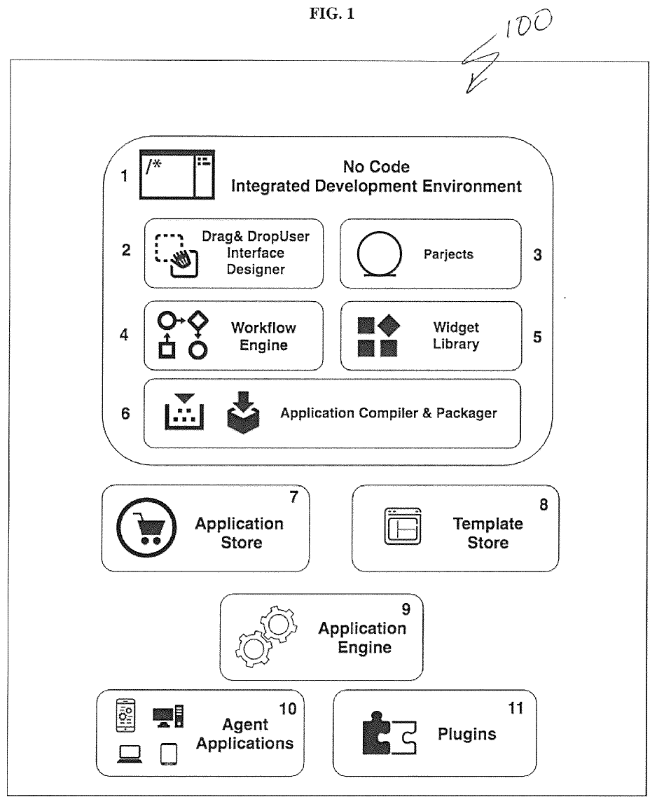

FIG. 1 shows entities of an object based application development system. A definition of each of the entities in FIG. 1 is provided below, with numbers referencing corresponding items and features in the accompanying drawing.

No Code Integrated Development Environment (IDE) (1): The no code integrated development environment is a main tool to give application developers ability to create applications over Parject based computing abstraction layer. IDE manages application and template development. Application project creation and development via drag and drop user interface designer, Parjects and workflow engine are the main practices of application development over IDE. Application compilers and packagers for web, mobile and desktop applications are provided via IDE.

Drag and Drop User Interface (UI) Designer (2): Application User Interfaces for any type of application are created over IDE using a UI Designer which provides capabilities for creating different pages for different use cases. UI Designer module works with drag & drop capability using widget library. Each widget can be added via drag & drop interaction and page design can be done with mouse and keyboard controls. Those controls include positioning, sizing, styling, cut, copy, paste, group and other configurations which can be done over widgets. IDE activities are completely done without coding and targets also non-coder developers as well as experienced ones.

Parjects (3): Parjects are the main components of the present invention and are the software part or portion as an object. Parjects represent a variety of capabilities of worldwide APIs and plugins which work on desktop and mobile devices. Parjects are used over IDE as they are added to application projects and used as capability set in the applications. Parjects are formed of a set of attributes, interactions and callback events. Attributes represents the data model and relationships with other Parjects. Interactions represents the interactions that an end user(s) can do over a data content. Callback events are the system interactions that triggers from system state changes. Parjects are software parts as objects, and they provide a large set of capabilities to create any type application. Parjects are created via conversion of APIs and each Parject can have more than one API provider. The computing abstraction layer creates a complete abstraction via Parjects over APIs. An application is developed using Parjects 3 and packaged once. Then each application buyer has freedom to configure their application instance with different provider per Parject or Parject group than other buyers.

Workflow Engine (4): Parject based application development system enables development of applications using UI elements and Parjects 3. The application and business logic of application and connection between them is provided via workflow engine. Workflow engine 4 has a set of activities for: using Parject 3 interactions via gathering inputs from UI widgets or other data sources like old Parject interaction results or variables; displaying Parject interaction results and their data on UI widgets or saving them for future usages; UI manipulation capabilities like page direction, changing UI behaviors on runtime; callback, widget and error event trigger handling. The workflow engine 4 provides application developers chance of easily changing the application behavior and ability to create any type of application for any type use cases.

Widget Library (5): Parject based application development system enables development of applications using UI widgets, Parjects 3 and workflow engine 4. UI Design of web, mobile and desktop applications are managed completely using widget library 5. Each widget is added to designer via drag & drop action and configured over designer. Each widget has a set of properties to be configured at application development time, widget events to reflect end user activities to workflow engine and a set of functions to give ability to change its property configurations at application run time. Widgets are customized to Parject 3 and other widget interactions to make the development environment without coding and minimum user interaction for any type application developers.

Application Compiler & Packager (6): The applications developed over IDE are compiled and converted to an application bundle depending on selected platform. It can be a web application, a desktop application or it can be a mobile application or all of them. The applications are compiled into related platform's application and packaged from IDE.

Application Store (7): The packaged applications developed over IDE are versioned and deployed to application store 7 if application developer wants to sell it. The application store 7 is the main container for applications which are developed for sale. Application buyer can buy applications and configure them according different licensing options, and Parject providers.

Template Store (8): The applications developed over IDE can be packaged as application template for other developers to use it as a base and edit it. Application templates are published on template store 8 for sale. Application developers who do not want to start from scratch will have ability to purchase a template and start development on it. Templates are just the packaged versions of application projects.

Application Engine (9): The provisioned applications run on the application engine 9. For each application, a containerized instance is prepared, and the application is run over it. All the resource management, scalability and maintenance of application is managed by application engine.

Agent Applications (10): Parjects 3 represent capabilities of worldwide APIs as well as any computational IP connected device capabilities. For each platform there is an agent application that provides exposition of device capabilities as Parjects 3. Agent applications are responsible for plugin management and communication with devices.

Plugins (11): Each capability that works on IP connected devices is represented as plugin and run by the agent application 10. Any new plugin 11 can be added to system or removed without changing agent application 10.

### Application and Template Development

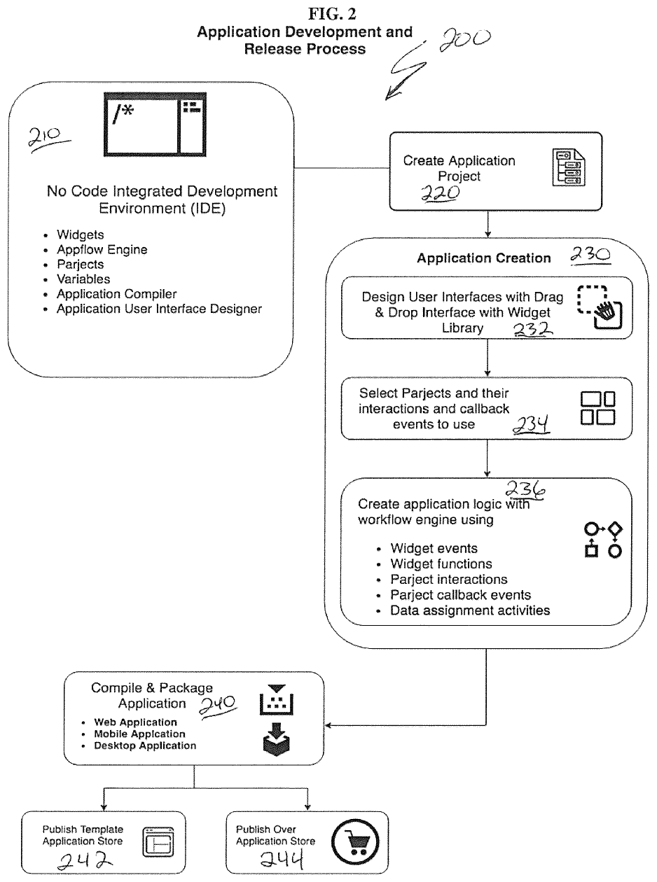

The application and template development is now described with reference to FIG. 2 for how the application development process 200 using Parjects 3 is managed. Parject based computing abstraction layer exposes as outputs like applications or templates. The application or template development process is very similar and the following activities are done during that process. Within the No Code Integrated Development environment 210, there exists the widgets, appflow engine, Parjects 3, variables, application compiler 6, and application user interface designer. The application project is created 220 according to purpose of application via platform selection web, mobile or desktop. Then, the Application development process includes a set of activities which depends on application, as shown with application creation step 230. Within the Application creation 230, there is design of user interfaces with a drag & drop designer and widget library 232, then adding Parjects 3 into project, by selecting Parjects 3 and their interactions and call back events to use 234; and then creating application logic with a workflow engine 236 combining one or more or all of: widget capabilities, such as widget events and widget functions with Parject interactions and callback events, and data assignment activities. After application creation is completed, the application development and release process 200 then performs compiling and packaging the application according to platform selection 240, including web application, mobile application, and desktop application. Depending on output, the process 200 includes publishing it as template for targeting application developers 242 or publish it as an application for targeting any type application buyers 244.

### Application Run Time Lifecycle Over Parjects

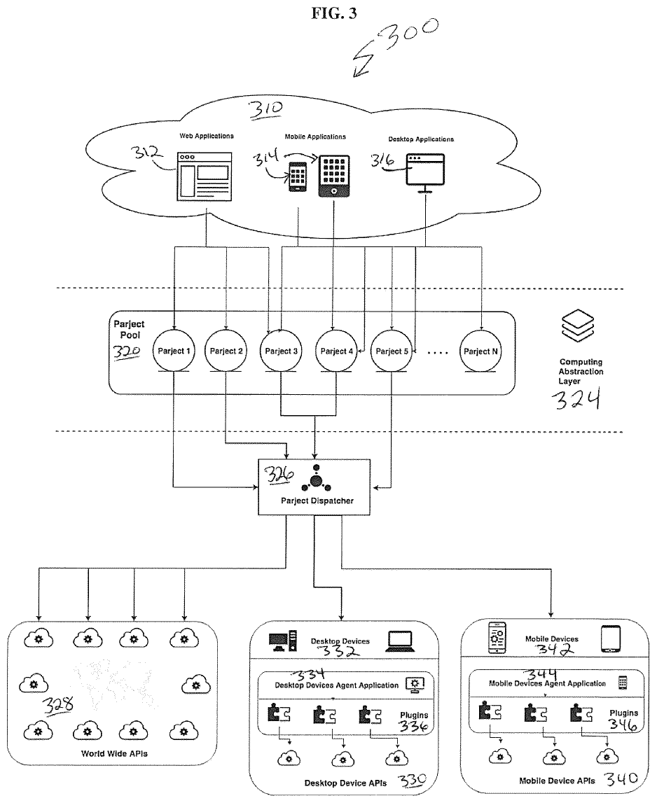

Referring to FIG. 3 for a description of how the Parject based computing abstraction layer 324 works during an application's lifecycle 300. The applications of type web application (312), mobile application (314) or desktop application (316) are created over IDE then packaged and published to application store. Each packaged application is provisioned with a specific configuration according to selection of application buyer. Each provisioned application runs on a cloud platform 310 which is based on Parject 3 based computing abstraction layer, 324, that is formed by a pool 320 of Parjects indicated by Parject-1 through Parject-N. Application interactions depending on the application logic is managed by application workflow engine. Application interactions are including Parject interactions as steps in the workflow engine 4. The flow of a Parject interaction can be illustrated as: Application logic requires an interaction which creates a Parject interaction usage. This Parject interaction goes over computing abstract layer 324 and sends a request to Parject Dispatcher module 326. The Parject Dispatcher module 326 checks the application provisioning information and finds the provider of related Parject. The Parject Dispatcher module 326 receives the provider mapping request of related Parject interaction. Depending on the type of request, it is sent to provider API (328,330,340). It can be either one that goes over a device-based API (330,340) or cloud API (328). Device based APIs are used for managing physical mobile (342) or desktop (332) devices. The device management capabilities are exposed via desktop agent applications (334) and mobile agent applications (344). Those agent applications (334,344) provide communication between Parject dispatcher (326) but their capabilities are exposed via desktop agent plugins (336) for desktop devices (332) and mobile agent plugins (346) for mobile devices (342). The result of Parject interaction is returns from the same path and come to Parject Dispatcher module (326) with a response mapping. The response is transmitted to application and application workflow logic continues to run.

### Applications'Lifecycle With Different Parject Providers

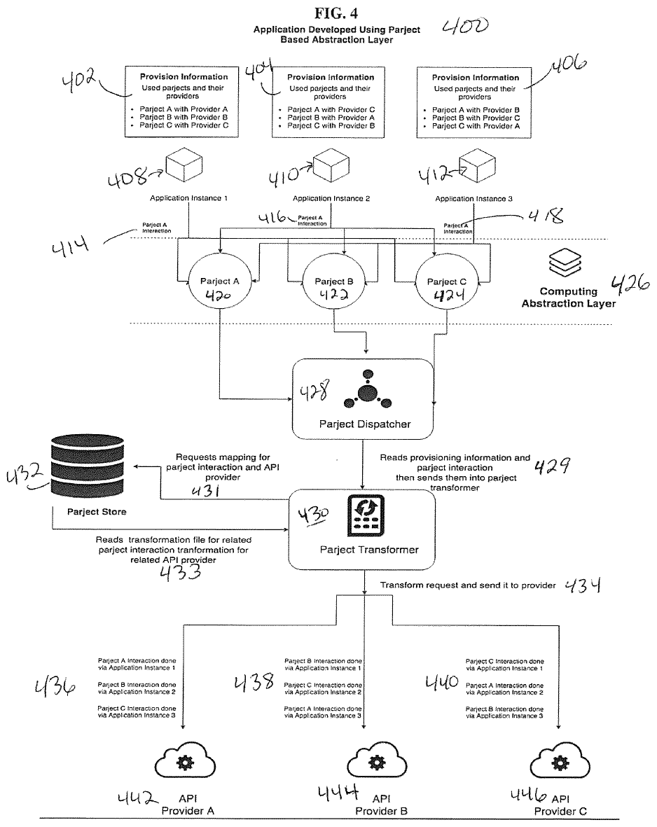

The applications'lifecycle with different Parject providers will now be described with reference to FIG. 4. As described in FIG. 4, there is shown how an application instance can work with different Parject providers. Applications developed over Parject based computing abstraction layer provides an abstract environment which enables same application to work with different API providers without editing anything in the application itself. An application 400 is created once but each instance is provisioned separately and has ability to be configured different. This capability forms the core part of this invention. Each application is only aware of Parjects which are the doors of an application to world APIs. A Parject can have more than one API provider with same capabilities and each provisioned instance of an application can use different providers for same application. However, each application instance behaves same and does same thing. This is achieved with Parject based computing abstraction layer (426) modules.

Referring again to FIG. 4, the following three flow paths simulates an application with three different application instances with three different Parject usages with three different provider provisioning. For the first path, Flow Path 1, the precondition is set as follows: Application Instance 1 (408) uses three Parject interactions which are interactions of Parject A (420), Parject B (422) and Parject C (424). Application Instance 1(408 ) is provisioned with Provision Information 1(402 ). The Parject interaction of A, Parject Interaction of B and Parject interaction of C is called from application instance. The Parject interactions are reflected to Parject Dispatcher (428) over Parject based computing abstraction layer (426) with Provisioning Information 1 (402 ). The Parject Dispatcher module 428 reads the Provisioning Information 1 (402) to get the provider information for used Parject. The Parject Dispatcher 428 passes Provisioning Information 1 (402 ) to Parject Transformer (430) module. Step (429). The Parject Transformer (430) module sends provider information and used Parject interactions to Parject Store (432) to get the mapped provider requests of Parject interactions. Step (431). The Parject Transformer (430) reads the transformation files for related Parject interaction transformations for related API provider from Parject Store (432). Step (433). The Parject Transformer (430) transforms the requests for related providers and send them to providers. Step (434). The request for interaction of Parject A is sent and communicated to API Provider A (442). Step (436). The request for interaction of Parject B is send and communicated to API Provider B (444). Step (438). The request for interaction of Parject C is send to API Provider C (446). Step (440). The responses from each of API Providers (442, 444, 446) follows the same path from opposite direction and finalizes as the Application Instance 1 (408) interaction result.

For the second path, Flow Path 2, the precondition is set as follows: Application Instance 2 (410) uses three Parject interactions which are interactions of Parject A (420), Parject B (422) and Parject C (424). Application Instance 1 (410 ) is provisioned with Provision Information 1 (404 ). The Parject interaction of A, Parject Interaction of B and Parject interaction of C is called from application instance. The Parject interactions are reflected to Parject Dispatcher (428) over Parject based computing abstraction layer (426) with Provisioning Information 2(404 ). The Parject Dispatcher module 428 reads the Provisioning Information 2 (404) to obtain the provider information for used Parject. The Parject Dispatcher passes Provisioning Information 2 (404 ) to Parject Transformer (430) module. Step (429). The Parject Transformer (430) module sends provider information and used Parject interactions to Parject Store (432) to obtain the mapped provider requests of Parject interactions. Step (431). The Parject Transformer (430) reads the transformation files for related Parject interaction transformations for related API provider from Parject Store (432). Step (433). The Parject Transformer (430) transforms the requests for related providers and sends them to providers. Step (434). The request for interaction of Parject A is send to API Provider C (446). Step (440). The request for interaction of Parject B is sent to API Provider A (442). Step (436). The request for interaction of Parject C is send to API Provider B (444). Step (438). The responses from API Providers (442,444,446) follows the same path from opposite direction and finalizes as the Application Instance 2 (410) interaction result.

For the third path in FIG. 4, Flow path 3, the precondition is set as follows: Application Instance 3 (412) uses 3 Parject interactions which are interactions of Parject A (420), Parject B (422) and Parject C (424). Application Instance 1 (412 ) is provisioned with Provision Information 1 (406 ). The Parject interaction of A, Parject Interaction of B and Parject interaction of C is called from application instance. The Parject interactions are reflected to Parject Dispatcher (428) over Parject based computing abstraction layer (426) with Provisioning Information 3 (406). The Parject Dispatcher module reads the Provisioning Information 3 (406) to obtain the provider information for used Parject. The Parject Dispatcher passes Provisioning Information 3 (406) to Parject Transformer (430) module. Step (429). The Parject Transformer (430) module sends provider information and used Parject interactions to Parject Store (432) to get the mapped provider requests of Parject interactions. Step (431). The Parject Transformer (430) reads the transformation files for related Parject interaction transformations for related API provider from Parject Store (432). Step (433). The Parject Transformer (430) transforms the requests for related providers and send them to providers. Step (434). The request for interaction of Parject A is sent and communicated to API Provider B (444). Step (438). The request for interaction of Parject B is send and communicated to API Provider C (446). Step (440). The request for interaction of Parject C is sent and communicated to API Provider A (442). Step (436). The responses from each of API Providers (442,444,446) follows the same path from opposite direction and finalizes as the Application Instance 3 (412) interaction result.

The present invention has numerous advantages as it provides a new computing abstraction layer for all over the world's computational capabilities. This invention provides for API providers to reach many audiences with increasing their value with combination with other APIs that they are not able realize. It removes walls between products as representing them as Parjects. Further, the present invention provides the advantage of a no code application development environment over computational abstraction layer of Parjects in which updating, orchestrating, and testing applications is very easy and does not require deep technical knowledge. Moreover, deploying and running applications requires no effort. The customization of applications are very effortless using applications templates.

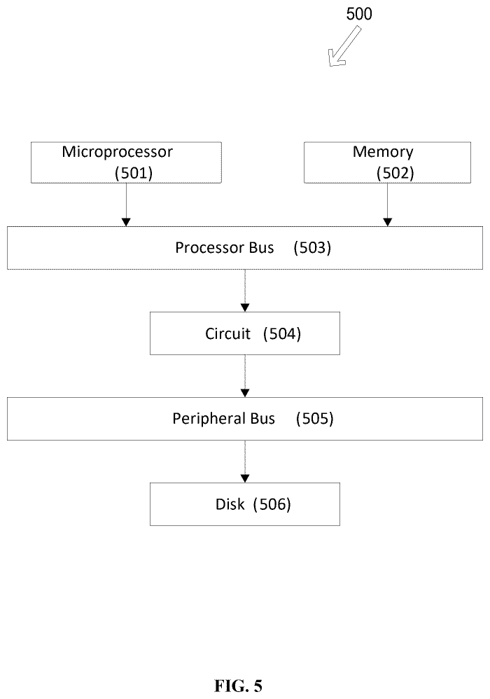

The present invention is used with the following FIG. 5 of computer systems, components, and internet access. FIG. 5 illustrates a system of a computer or device which includes a microprocessor 501 and a memory 502 which are coupled to a processor bus 503 which is coupled to a peripheral bus 505 by circuitry 504. The bus 505 is communicatively coupled to a disk 506. It should be understood that any number of additional peripheral devices are communicatively coupled to the peripheral bus 505 in embodiments of the invention. Further, the processor bus 503, the circuitry 504 and the peripheral bus 505 compose a bus system for computing system 500 in various embodiments of the invention. The microprocessor 501 starts disk access commands to access the disk 506. Commands are passed through the processor bus 503 via the circuitry 504 to the peripheral bus 505 which initiates the disk access commands to the disk 506. In various embodiments of the invention, the present system intercepts the disk access commands which are to be passed to the hard disk.

The present invention, an “easy use of flows” system, automates the process of configuring workflows by first identifying the necessary account details required for each specific workflow and then prompting the user to provide these details through a user-friendly interface. This proactive approach significantly reduces the complexity typically associated with manual data entry and workflow configuration in traditional flow editors.

The “easy use of flows” of the present invention is designed to simplify how users interact with and execute workflows by streamlining the setup process. This system enables users to import and utilize community-shared workflows without the need to open or interact with a flow editor. Users can select a desired workflow from a library of thousands, and the system intelligently prompts them to input their specific account details and authorization information. Once these inputs are provided, the workflow can be executed directly, allowing users to immediately see and evaluate its performance.

The present invention works in the following manner. First, there is “Workflow Import and Selection”, where users are provided with an interface where they can browse and select from a wide array of available workflows shared by the community. This selection process is user-friendly and designed to be accessible even to those with minimal technical knowledge.

Next, there is “Automated Prompting for Inputs.” After selecting a workflow, the system automatically determines what account details and authorization information are required for its execution. It then prompts the user to enter these details, guiding them through the process to ensure all necessary information is captured accurately.

The next step is “Direct Execution and Feedback.” With all required information inputted, users can directly run the workflow. The system immediately executes the workflow and provides users with real-time feedback on its operation. This allows users to quickly assess how the workflow functions with their specific data and settings.

In order to make changes, additions, and improvements to the system of the present invention, various steps can be made. This includes elimination of flow editors and a streamlines setup process. Unlike traditional methods that require users to manipulate workflows within complex editors, this invention removes the need to interact with such technical interfaces of flow editors, vastly simplifying the user experience. For the streamlined setup process, the process of setting up a workflow is significantly accelerated by the automated prompting for necessary inputs. This reduces the time from selection to execution, enhancing productivity.

There is also an increased accessibility by the present invention. By simplifying the interface and reducing the technical skills required to operate it, the system becomes accessible to a broader audience, allowing more users to benefit from powerful workflow automation.

The present invention also allows for immediate usability testing. Users can immediately test and validate the functionality of workflows in their specific context, providing an instant understanding of the workflow's effectiveness and facilitating quicker adjustments if necessary.

This comprehensive approach not only makes workflow automation more accessible but also enhances the efficiency and usability of managing and executing complex processes. The design and operation of the system are detailed enough that a professional in the field could recreate and implement it based on this description, ensuring that it meets the practical and technical requirements of modern workflow management.

The “easy use of flows” invention has introduced several unexpected benefits that have significantly enhanced user experience and operational efficiency. One of the most notable outcomes is the dramatic reduction in the learning curve required for new users. Traditionally, a substantial understanding of workflow configurations was necessary, but now, even novices can efficiently set up and run complex workflows with minimal instruction. This accelerated proficiency has been especially beneficial in environments where quick deployment and ease of use are critical. Moreover, the system has fostered a surprising increase in workflow adoption among non-technical users who were previously deterred by the complexity of traditional flow editors. This broadened usability enhances organizational agility, allowing more team members to engage in process automation efforts without needing extensive training. Furthermore, the invention has significantly minimized setup errors by automating the input of account details and authorization information, reducing human error and increasing the reliability and speed of workflow executions. These improvements have not only streamlined the management of workflows but also boosted user confidence and operational reliability, marking a substantial advancement over existing methods.

The present invention's “easy use of flows” system is a sophisticated software tool designed to simplify the process of setting up and executing workflows by automating the identification and collection of necessary account details. This tool is intended primarily for users who need to integrate and automate workflows across various platforms without in-depth technical knowledge of the underlying systems.

A primary purpose of the present invention “easy use of flows” system is to facilitate the seamless setup and operation of workflows by reducing the complexity typically associated with manual configurations. It achieves this by automatically prompting users for essential account and authorization details required to run selected workflows.

In usage, the present invention has an “Efficiency in Workflow Management.” This quickly imports and executes community-shared workflows, eliminating the need for manual data entry or adjustment of flow settings in complex editors. There is also accessibility for non-technical users by the present invention, which simplifies the user interface to a level that non-technical personnel can easily navigate, thereby broadening the scope of who can effectively use workflow automation tools. The present invention also has the benefit of error reduction and minimizes the risk of errors by automating the input of necessary data, which traditionally could lead to issues if entered incorrectly.

The present invention includes the features of:

Automated Data Prompting: As soon as a user selects a workflow, the system automatically identifies and requests the specific account details and permissions needed for the workflow to run correctly.

Direct Execution Capability: Users can run workflows immediately after providing the required information, with the system handling all aspects of the execution process.

Real-time Feedback and Adjustments: Provides users with immediate feedback on the execution of the workflow, allowing for quick adjustments and learning.

This software is ideally suited for organizations looking to streamline their workflow processes, especially those that require frequent updates or integration of new systems and services. It is also beneficial in environments where there is a high turnover of tasks requiring rapid familiarization with workflow tools by diverse teams.

The present invention “easy use of flows” system introduces several novel aspects that differentiate it from existing software on the market, particularly focusing on enhancing user accessibility and streamlining the integration and execution of workflows. These innovations address and overcome significant deficiencies found in current workflow management tools.

Some of the novel aspects of the present invention “easy use of flows” system follow.

User-Centric Design: Unlike traditional systems that require users to navigate complex flow editors, this present invention allows users to import and run workflows directly from a simplified interface. This design significantly reduces the technical skill required, making it accessible to a broader range of users, including those with minimal or no technical background.

Automated Account Setup: The system automatically identifies the specific account details and authorization information needed for each selected workflow. It then prompts the user to provide these details, streamlining the setup process. This feature eliminates the common manual entry errors associated with traditional systems and speeds up the workflow configuration.

Immediate Execution and Feedback: Once the necessary details are inputted, users can immediately execute the workflow. The system provides real-time feedback on its operation, allowing users to quickly see and understand how the workflow functions with their specific settings. This instant feedback is crucial for optimizing workflows without the iterative trial and error typically required in other systems.

Community Integration and Sharing: The present invention facilitates easy access to a community-driven library of workflows. Users can import any workflow shared by the community, customize it with their account details, and deploy it within minutes. This capability greatly enhances the collaborative potential and adaptability of the software, encouraging innovation and sharing among users.

The present invention overcomes deficiencies in existing products by providing reduced complexity, decreased dependency on technical expertise, and enhance efficiency and productivity. For reduced complexity by the present invention, traditional tools often involve complex interfaces that can be daunting for non-technical users. The present invention “easy use of flows” system simplifies the entire process, from selection to execution, making it more user-friendly and less intimidating. For decreased dependency on technical expertise with the present invention, by automating the identification of required inputs and simplifying user interactions, the system reduces the reliance on specialized knowledge, which can be a barrier in many organizations. For enhanced efficiency and productivity, the streamlined process allows users to set up and modify workflows quickly, significantly reducing downtime and increasing the overall throughput of workflow executions.

These innovative aspects make the present invention “easy use of flows” a pioneering solution in the realm of workflow automation, providing substantial improvements over existing methods by making powerful workflow tools accessible and practical for a wider range of users.

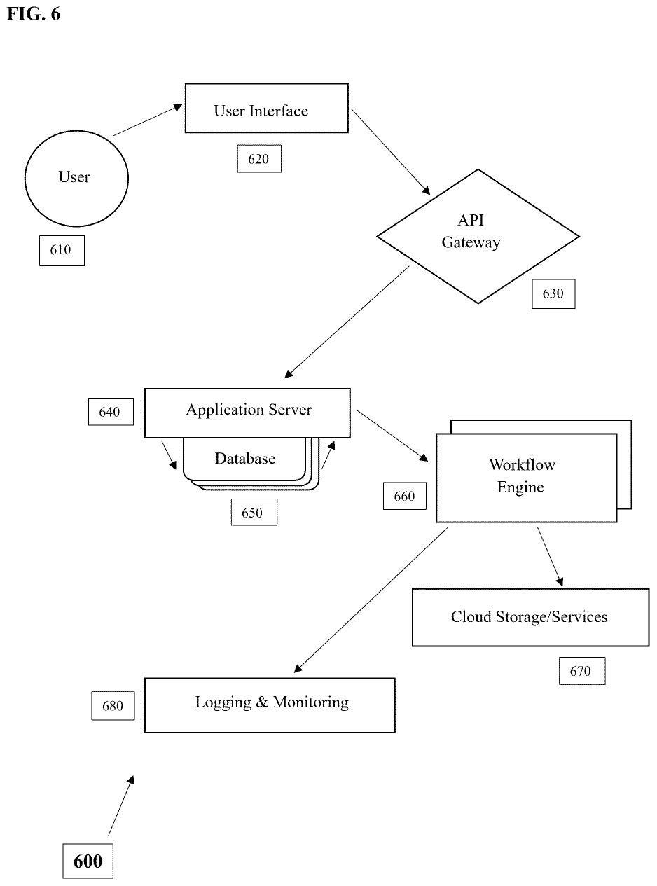

The “easy use of flows” system is structured around a modern computer architecture designed to facilitate seamless workflow integration and user interaction. This architecture consists of several key components that work together to ensure the system is robust, efficient, and scalable. A detailed breakdown of the core components and their functions within the system is described below and with reference to FIG. 6.

The key components of the system architecture of the present invention is as follows. First, there is a User Interface (UI) 620. This has the function of providing a simple, intuitive interface for users to interact with the system. It allows users to search, select, and import workflows from a community-driven library and input necessary account details and authorization information without needing to access a traditional flow editor.

A central processing unit (CPU) is also included, and as indicated generally with FIG. 5. The central processor unit executes the software instructions, and handles the logic and processing required to automate the setup and execution of workflows. The central processing unit is critical for the rapid execution of complex workflows and real-time data processing.

The present invention includes one or more servers. These have the function of hosting the backend services, including the workflow management system, user authentication, and session management. Servers also handle heavy-duty processing tasks, such as workflow execution, data encryption, and network communications.

One or more databases are included in the present invention. The databases have the function of storing and managing all data related to workflows, user accounts, and execution histories. The databases ensure data integrity and provide fast access to necessary information, enabling the system to quickly retrieve and store user inputs and workflow details.

The application programming interface (API) 630 has the function of facilitating communication between the user interface 620 and backend servers 640. APIs are used to query the database 650 for workflow information, submit user inputs, and initiate workflow executions.

The network infrastructure of the present invention supports all data transmission between the system components, including user inputs from the UI to the servers and back-end processing results back to the UI. This includes both internal network connections within a secure environment and external connections for accessing cloud-based services.

The present invention includes storage systems which provide scalable storage solutions for storing extensive libraries of workflows, user data, and system logs. These systems ensure data redundancy and high availability of information.

Security systems are included with the present invention. These manage authentication, authorization, and encryption services to protect user data and prevent unauthorized access to the system. Security systems are integral in maintaining the integrity and confidentiality of sensitive information.

There are also cloud services included with the present invention. This is to offer additional computing power and storage capabilities via the cloud. Cloud services can be scaled dynamically to accommodate varying loads, especially useful during peak times when multiple users are executing workflows simultaneously.

This architecture not only supports the basic operational needs of the “easy use of flows” system but also ensures that it can scale to meet the demands of a growing user base and handle complex integrations smoothly. The system's design is focused on minimizing latency, maximizing reliability, and providing a user-friendly experience that requires minimal technical expertise.

The components are interconnected through secure, high-speed networks, ensuring that data transfer between them is swift and safe. APIs facilitate the communication between the frontend and backend services, while middleware solutions manage data consistency and transaction integrity.

In referring to FIG. 6, there is shown the present invention 600. The user 610 accesses the computing device which displays the user interface 620 which is in communication with the API gateway 630. The API gateway 630 communicates with the application server 640. Calls are made from the application server 640 to the database 650 which returns the information and data requested to the application server 640. The application server 640 is in communication with the workflow engine 660, transferring any information or data received from the database 650. The workflow engine 660 communicates with cloud storage/services 670 and logging/monitoring services 680. All communications are done with secure, high speed networks.

The “easy use of flows” invention incorporates significant technological advancements that enable non-technical users to initiate and manage workflows directly from a simplified user interface or a community-driven marketplace. This capability is underpinned by several key technological innovations. Firstly, the system employs an advanced user interface (UI) technology that abstracts the complexities of workflow management into a streamlined, intuitive process. This UI dynamically adjusts to display only the relevant information and controls needed for each specific user or workflow, thereby simplifying user interactions that were previously complex and error-prone. Moreover, the backend of the system integrates sophisticated algorithms that automatically detect and configure the necessary workflow parameters based on minimal user input. The technology supports seamless integration with a marketplace where pre-configured workflows are available. This integration is made possible through advanced API connectivity, which ensures that workflows can be easily discovered, customized, and executed within the system without the need for users to ever engage directly with complex workflow editors.

These technological advancements not only enhance the user experience but also represent a significant improvement in the technical infrastructure of workflow management systems. They demonstrate a clear technological progression from previous methods that required technical expertise, moving towards a more inclusive and accessible technology that empowers all users to effectively manage workflows with ease. This shift not only broadens the applicability of the system but also underscores the innovative technological contributions of the “easy use of flows” system

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” or “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “computer readable storage medium” may be any tangible medium (but not a signal medium—which is defined below) that can contain, or store a program. The terms “machine readable medium,” “computer-readable medium,” or “computer readable storage medium” are all non-transitory in their nature and definition. Non-transitory computer readable media comprise all computer-readable media except for a transitory, propagating signal.

The term “machine-readable signal” refers to any signal used to provide machine instructions and/or data to a programmable processor. A “computer readable signal medium” may be any computer readable medium that is not a computer readable storage medium and that can communicate, propagate, or transport a program.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Elements of different implementations described herein may be combined to form other implementations not specifically set forth above. Elements may be left out of the processes, computer programs, Web pages, etc. described herein without adversely affecting their operation. Furthermore, various separate elements may be combined into one or more individual elements to perform the functions described herein.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

What is claimed is:

1. A method for management of workflow processes in applications comprising:
accessing a computing device which displays a user interface, said user interface in communication with an api gateway;
communicating with an application server by said api gateway;
requesting, by said api gateway, from said application server to a database for information and data;
returning from said database said information and data to said application server;
transferring, by said application server, said information and data received from said database to a workflow engine;
communicating by said workflow engine to a cloud storage; and
communicating by said workflow engine with logging and monitoring services.
